(19) United States
(12) Patent Application Publication
(10) Pub. No.: US 2025/0373272 A1
(43) Pub. Date: Dec. 4, 2025

(54) METHOD FOR PERFORMING ANTENNA CONTROL WITH AID OF JOINT DECISION OF ANTENNA SELECTION AND TUNING FOR ANTENNA PERFORMANCE OPTIMIZATION, AND ASSOCIATED APPARATUS

(71) Applicant: MEDIATEK INC., Hsin-Chu (TW)

(72) Inventors: Yen-Liang Chen, Hsinchu City (TW); Po-Chung Hsiao, Hsinchu City (TW); Chun-Hsiang Chen, Hsinchu City (TW); Chin-Wei Hsu, Hsinchu City (TW); Sin-Sheng Wong, Hsinchu City (TW)

(73) Assignee: MEDIATEK INC., Hsin-Chu (TW)

(21) Appl. No.: 18/676,463

(22) Filed: May 28, 2024

(51) Int. Cl. H04B 1/00; H04B 1/52; H04B 17/18; H04B 17/20; H04B 17/29; H04B 17/318; H04W 52/36

(52) U.S. Cl. CPC H04B 1/0078; H04B 1/52; H04B 17/18; H04B 17/203; H04B 17/296; H04B 17/328; H04W 52/365

(57) ABSTRACT

A method for performing antenna control in a wireless communications system with aid of joint decision of antenna selection and tuning for antenna performance optimization and associated apparatus are provided. The method may include: during a runtime stage among multiple stages, dynamically determining any action of a state change among multiple actions according to a set of runtime measurements and a pre-defined database in a storage device within the wireless transceiver device; and during the runtime stage, performing the any action to selectively adjust a hybrid state of the wireless transceiver device, the hybrid state being a combination of a switch state of a switch circuit for antenna selection within the communication control circuit and at least one tuner state of at least one antenna tuner for antenna tuning within the communication control circuit, for performing at least one adjustment among a switch state adjustment and a tuner state adjustment.

### BACKGROUND

The present invention is related to communication control, and more particularly, to a method for performing antenna control with aid of joint decision of antenna selection and tuning for antenna performance optimization, and associated apparatus such as a wireless transceiver device.

According to the related art, a wireless communication device in a telecommunication system (e.g., 4G or 5G systems) may be arranged to send or receive data wirelessly, through one or more antennas thereof, in order to provide one or more services to the user of the wireless communication device. Some problems such as reduced antenna performance, degraded antenna efficiency, etc. may occur. More particularly, antenna selection and antenna tuning techniques could be both applied on user equipment (UE) to improve antenna performance. Independent operations of selection and tuning may lead to conflicts or non-optimal decisions. For example, the antenna selection may cause a switch state change, which may affect the optimality of the tuning result. In addition, the antenna tuning may cause a tuner state change, leading to variations of associated information used for the antenna selection. As existing solutions in the related art merely focus on independent methods of either the antenna selection or the antenna tuning techniques, the system performance is typically not optimized. Thus, a novel method and associated architecture are needed for solving the problems without introducing any side effect or in a way that is less likely to introduce a side effect.

### SUMMARY

It is an objective of the present invention to provide a method for performing antenna control with aid of joint decision of antenna selection and tuning for antenna performance optimization, and associated apparatus such as a wireless transceiver device (e.g., a multifunctional mobile phone), in order to solve the above-mentioned problems.

At least one embodiment of the present invention provides a method for performing antenna control with aid of joint decision of antenna selection and tuning for antenna performance optimization, where the method can be applied to a wireless transceiver device. The method may comprise: during a runtime stage among multiple stages, dynamically determining, by a communication control circuit within the wireless transceiver device, any action of a state change among multiple actions according to a set of runtime measurements and a pre-defined database in a storage device within the wireless transceiver device; and during the runtime stage, performing, by the communication control circuit, the any action to selectively adjust a hybrid state of the wireless transceiver device, the hybrid state being a combination of a switch state of a switch circuit for antenna selection within the communication control circuit and at least one tuner state of at least one antenna tuner for antenna tuning within the communication control circuit, for performing at least one adjustment among a switch state adjustment and a tuner state adjustment.

At least one embodiment of the present invention provides a wireless transceiver device for performing antenna control of the wireless transceiver device in a wireless communication system with aid of joint decision of antenna selection and tuning for antenna performance optimization, where the wireless transceiver device may be one of multiple devices within the wireless communications system. The wireless transceiver device may comprise a processing circuit that is arranged to control operations of the wireless transceiver device. The wireless transceiver device may further comprise at least one communications control circuit that is coupled to the processing circuit and arranged to perform communications control, where the aforementioned at least one communications control circuit is arranged to perform wireless communications operations with a network within the wireless communications system for the wireless transceiver device. For example, during a runtime stage among multiple stages, the aforementioned at least one communication control circuit is arranged to dynamically determine any action of a state change among multiple actions according to a set of runtime measurements and a pre-defined database in a storage device within the wireless transceiver device; and during the runtime stage, the aforementioned at least one communication control circuit is arranged to perform the any action to selectively adjust a hybrid state of the wireless transceiver device, the hybrid state being a combination of a switch state of a switch circuit for antenna selection within the communication control circuit and at least one tuner state of at least one antenna tuner for antenna tuning within the communication control circuit, for performing at least one adjustment among a switch state adjustment and a tuner state adjustment.

It is an advantage of the present invention that, through proper design, the present invention method, as well as the associated apparatus such as the wireless transceiver device (e.g., the multifunctional mobile phone), can adaptively make joint decision of antenna selection and tuning to perform antenna control for antenna performance optimization. Additionally, the present invention method and apparatus can solve the related art problems without introducing any side effect or in a way that is less likely to introduce a side effect.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of a wireless communication system according to an embodiment of the present invention.

FIG. 2 illustrates an antenna selection control scheme of a method for performing antenna control with aid of joint decision of antenna selection and tuning for antenna performance optimization according to an embodiment of the present invention.

FIG. 3 illustrates an antenna tuning control scheme of the method according to an embodiment of the present invention.

FIG. 4 illustrates a working flow of the method regarding a certain stage among multiple stages according to an embodiment of the present invention.

FIG. 5 illustrates a 1T2R joint antenna selection and tuning architecture in at least one default state according to an embodiment of the present invention.

FIG. 6 illustrates the 1T2R joint antenna selection and tuning architecture in a first tuner state according to an embodiment of the present invention.

FIG. 7 illustrates the 1T2R joint antenna selection and tuning architecture in a second tuner state according to an embodiment of the present invention.

FIG. 8 illustrates the 1T2R joint antenna selection and tuning architecture in a first switch state according to an embodiment of the present invention.

FIG. 9 illustrates the 1T2R joint antenna selection and tuning architecture in the first switch state and another tuner state according to an embodiment of the present invention.

FIG. 10 illustrates the 1T2R joint antenna selection and tuning architecture in the first switch state according to another embodiment of the present invention.

FIG. 11 illustrates the 1T2R joint antenna selection and tuning architecture in the restored switch state according to the embodiment shown in FIG. 10.

FIG. 12 illustrates a wireless transceiver device equipped with the joint antenna selection and tuning architecture shown in FIG. 2 according to an embodiment of the present invention.

FIG. 13 illustrates a working flow of the method regarding the multiple stages according to an embodiment of the present invention.

### DETAILED DESCRIPTION

Certain terms are used throughout the following description and claims, which refer to particular components. As one skilled in the art will appreciate, electronic equipment manufacturers may refer to a component by different names. This document does not intend to distinguish between components that differ in name but not in function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

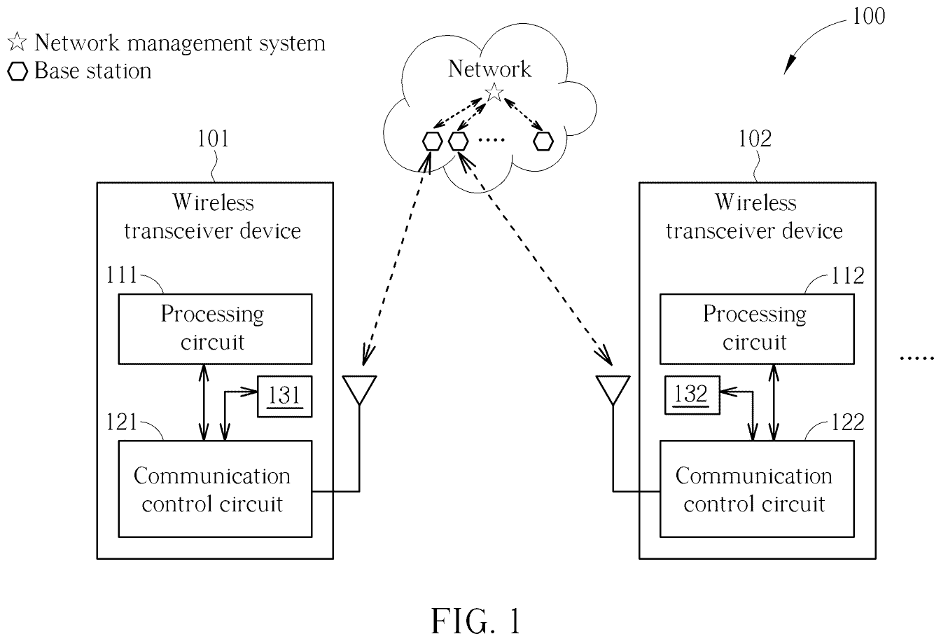

FIG. 1 is a diagram of a wireless communication system 100 according to an embodiment of the present invention. For better comprehension, the wireless communication system 100, as well as any wireless transceiver device among multiple wireless transceiver devices #1, . . . and #N therein, may be compatible or back-compatible to one or more versions of predetermined wireless telecommunication standards, and more particularly, the wireless communication system 100 may comprise a network such as that of any system among the third generation (3G) system, the fourth generation (4G) system, the fifth generation (5G) system, etc., where “N” may represent a positive integer that is greater than one, but the present invention is not limited thereto. For example, the network may comprise a network management system for managing the network, and comprise multiple base stations for facilitating wireless communication between user equipment (UE) and the network, and the multiple base stations may be implemented by way of base transceiver station (BTS), Node B, evolved Node B (eNB), gNodeB (gNB), etc. Regarding the multiple wireless transceiver devices #1, . . . and #N within the wireless communication system 100, a wireless transceiver device 101 may represent the wireless transceiver device #1, a wireless transceiver device 102 may represent the wireless transceiver device #2, and the rest may be deduced by analogy. According to some embodiments, assuming that “n” may be an integer in the interval [1, N], the wireless transceiver device #n among the multiple wireless transceiver devices #1, . . . and #N may be illustrated as the n^{th} wireless transceiver device 10_n among the wireless transceiver devices {10_n|n=1, 2, . . . }, and the wireless transceiver devices {10_n|n=1, 2, . . . } may be referred to as the wireless transceiver device 101, the wireless transceiver device 102, etc. for brevity. As shown in FIG. 1, the wireless transceiver device 101 may comprise a processing circuit 111, at least one communication control circuit (e.g., one or more communication control circuits) which may be collectively referred to as the communication control circuit 121, at least one antenna (e.g., one or more antennas) of the communication control circuit 121, and a storage device 131, the wireless transceiver device 102 may comprise a processing circuit 112, at least one communication control circuit (e.g., one or more communication control circuits) which may be collectively referred to as the communication control circuit 122, at least one antenna (e.g., one or more antennas) of the communication control circuit 122, and a storage device 132, and the rest may be deduced by analogy.

In the architecture shown in FIG. 1, the processing circuit 111 can be arranged to control operations of the wireless transceiver device 101, the communication control circuit 121 can be arranged to perform communication control, and more particularly, perform wireless communication operations with the network (or the base stations thereof) for the wireless transceiver device 101, and the storage device 131 can be arranged to store information, and can be coupled to the communication control circuit 121 to allow the communication control circuit 121 to access (e.g., read or write) the storage device 131, and similarly, the processing circuit 112 can be arranged to control operations of the wireless transceiver device 102, the communication control circuit 122 can be arranged to perform communication control, and more particularly, perform wireless communication operations with the network (or the base stations thereof) for the wireless transceiver device 102, and the storage device 132 can be arranged to store information, and can be coupled to the communication control circuit 122 to allow the communication control circuit 122 to access (e.g., read or write) the storage device 132, but the present invention is not limited thereto. The storage device 131 can be coupled to the processing circuit 111 for being accessed by the processing circuit 111 and storing information under control of the processing circuit 111, the storage device 132 can be coupled to the processing circuit 112 for being accessed by the processing circuit 112 and storing information under control of the processing circuit 112, and the rest may be deduced by analogy.

According to some embodiments, any processing circuit among the processing circuits 111, 112, etc. can be implemented by way of at least one processor/microprocessor, at least one random access memory (RAM), at least one bus, etc., any communication control circuit among the communication control circuits 121, 122, etc. can be implemented by way of at least one wireless network control circuit, and any storage device among the storage devices 131, 132, etc. can be implemented by way of at least one non-volatile memory such as at least one electrically erasable programmable read-only memory (EEPROM), at least one Flash memory, etc., but the present invention is not limited thereto. Examples of the wireless transceiver devices 101, 102, etc. may include, but are not limited to: a multifunctional mobile phone, a laptop computer, a tablet computer, an all-in-one computer and a wearable device.

The wireless communication system 100 as well as the multiple wireless transceiver devices #1, . . . and #N therein such as the wireless transceiver devices 101, 102, etc. may be compatible or back-compatible to the one or more versions of the predetermined wireless telecommunication standards such as the 3G standards, the 4G standards, the 5G standards, etc., but the present invention is not limited thereto. For example, the wireless communication system 100 as well as the multiple wireless transceiver devices #1, . . . and #N such as the wireless transceiver devices 101, 102, etc. may be compatible or back-compatible to one or more versions of the 3rd Generation Partnership Project (3GPP) standards. According to some embodiments, the network and/or the multiple wireless transceiver devices #1, . . . and #N such as the wireless transceiver devices 101, 102, etc. may vary, and/or the one or more versions of the predetermined wireless telecommunication standards may be replaced by one or more versions of predetermined communication standards, or may be replaced by any combination of the one or more versions of the predetermined wireless telecommunication standards and the one or more versions of the predetermined communication standards. For example, the multiple wireless transceiver devices #1, . . . and #N such as the wireless transceiver devices 101, 102, etc. may be compatible or back-compatible to one or more versions of the Institute of Electrical and Electronics Engineers (IEEE) 802.11 standards. In some examples, the multiple wireless transceiver devices #1, . . . and #N such as the wireless transceiver devices 101, 102, etc. may be compatible or back-compatible to one or more versions of some other standards such as that of Worldwide Interoperability for Microwave Access (WiMAX) or other wide area network (WAN) technology. In some examples, the multiple wireless transceiver devices #1, . . . and #N such as the wireless transceiver devices 101, 102, etc. may be compatible or back-compatible to one or more versions of wireless local area network (WLAN)-related standards using one or more radio access technologies such as the Long Term Evolution (LTE) technology, the New Radio (NR) technology, etc.

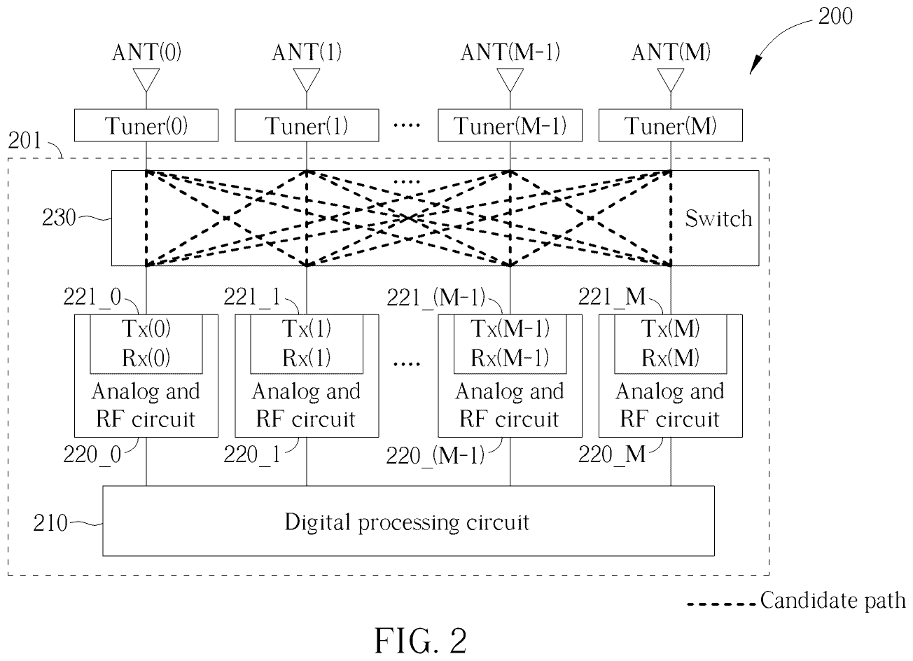

FIG. 2 illustrates an antenna selection control scheme of a method for performing antenna control with aid of joint decision of antenna selection and tuning for antenna performance optimization according to an embodiment of the present invention. The method is applicable to the aforementioned any wireless transceiver device among the multiple wireless transceiver devices #1, . . . and #N within the wireless communication system 100 shown in FIG. 1, such as any of the wireless transceiver devices 101, 102, etc., to integrate an antenna selection mechanism and an antenna tuning mechanism into a joint antenna selection and tuning architecture 200 in the UE antenna and frontend (FE) design thereof, for performing antenna selection and antenna tuning with joint consideration, and more particularly, performing the antenna selection to select active antennas to prevent antenna blocking by hand/head or other user scenarios to improve system performance or power consumption and performing the antenna tuning to restore the antenna efficiency which may have been degraded due to trade-off between efficiency, larger frequency-range support and shrinking size for more antennas, in order to enhance the antenna performance and therefore reach the optimized system performance.

As shown in FIG. 2, the joint antenna selection and tuning architecture 200 of the aforementioned any wireless transceiver device may comprise the communication control circuit 201 of the aforementioned any wireless transceiver device as well as multiple antennas such as the (M+1) antennas ANT(0), ANT(1), . . . , ANT(M−1) and ANT(M), and the communication control circuit 201 may comprise a digital processing circuit 210, multiple analog and radio frequency (RF) circuits such as the (M+1) analog and RF circuits 220_0, 220_1, . . . , 220_(M−1) and 220_M, a switch circuit 230 (labeled “Switch” for brevity), and multiple antenna tuners such as the (M+1) antenna tuners Tuner(0), Tuner(1), . . . , Tuner(M−1) and Tuner(M), where “M” may represent a positive integer. More particularly, the (M+1) analog and RF circuits 220_0, 220_1, . . . , 220_(M−1) and 220_M may comprise their own FE circuits 221_0, 221_1, . . . , 221_(M−1) and 221_M. For example, the first M FE circuits {221_0, 221_1, . . . , 221_(M−1)} and the last FE circuit 221_M among the (M+1) FE circuits 221_0, 221_1, . . . , 221_(M−1) and 221_M may be implemented as M transmitting (Tx) and receiving (Rx) FE circuits {221_0, 221_1, . . . , 221_(M−1)} comprising their own transmitters {Tx(0), Tx(1), . . . , Tx(M−1)} and receivers {Rx(0), Rx(1), . . . , Rx(M−1)} and one Rx FE circuit 221_M comprising its own receiver Rx(M) (respectively labeled as {{Tx(0), Rx(0)}, {Tx(1), Rx(1)}, . . . , {Tx(M−1), Rx(M−1)}, Rx(M)} for better comprehension). The joint antenna selection and tuning architecture 200 may be equipped with the M-transmit, (M+1)-receive (or M−T, (M+1)−R) antenna configuration, and therefore may also be referred to as the M−T, (M+1)−R joint antenna selection and tuning architecture 200, for example, the 1T2R joint antenna selection and tuning architecture 200 if M=1, or the 4T5R joint antenna selection and tuning architecture 200 if M=4, but the present invention is not limited thereto. In some examples, the antenna configuration of the joint antenna selection and tuning architecture 200 may vary.

The digital processing circuit 210 may be arranged to control operations of the communication control circuit 201, and perform digital processing for the communication control circuit 201. The (M+1) analog and RF circuits 220_0, 220_1, . . . , 220_(M−1) and 220_M may be arranged to perform analog and RF processing on multiple analog and RF processing paths (e.g., the signal paths starting from the digital processing circuit 210, passing through the (M+1) analog and RF circuits 220_0, 220_1, . . . , 220_(M−1) and 220_M as well as the (M+1) antenna tuners Tuner(0), Tuner(1), . . . , Tuner(M−1) and Tuner(M), and reaching the (M+1) antennas ANT(0), ANT(1), . . . , ANT(M−1)) for the communication control circuit 201. In addition, the switch circuit 230 may be arranged to provide multiple candidate paths between the (M+1) analog and RF circuits 220_0, 220_1, . . . , 220_(M−1) and 220_M (or the (M+1) FE circuits 221_0, 221_1, . . . , 221_(M−1) and 221_M thereof) and the (M+1) antenna tuners Tuner(0), Tuner(1), . . . , Tuner(M−1) and Tuner(M), such as (M+1) connection paths at a time, for performing the antenna selection for the communication control circuit 201 under control of the digital processing circuit 210. For example, the digital processing circuit 210 may select any antenna ANT(m) among the (M+1) antennas ANT(0), ANT(1), . . . , ANT(M−1) and ANT(M) as the antenna ANT(m) coupled to any FE circuit 221_m among the (M+1) FE circuits 221_0, 221_1, . . . , 221_(M−1) and 221_M, where “m” may be an integer in the interval [0, M]. When each FE circuit 221_m among the FE circuits {221_m|m=0, 1, . . . , (M−1), M} is coupled to an antenna ANT(m) among the antennas {ANT(m)|m=0, 1, . . . , (M−1), M}, there may be (M*(M−1)* . . . *2*1) candidate switch states of the switch circuit 230 in total, and these candidate switch states of the switch circuit 230 may be regarded as predetermined switch states of the switch circuit 230 for being selected. Additionally, the (M+1) antenna tuners Tuner(0), Tuner(1), . . . , Tuner(M−1) and Tuner(M) may be arranged to perform the antenna tuning on the (M+1) antennas ANT(0), ANT(1), . . . , ANT(M−1) and ANT(M) for the communication control circuit 201 under control of the digital processing circuit 210. The digital processing circuit 210 may control any antenna tuner Tuner(m) among the antenna tuners {Tuner(m)|m=0, 1, . . . , (M−1), M} to perform the antenna tuning on the corresponding antenna ANT(m) according to any antenna-tuning configuration among multiple predetermined antenna-tuning configurations of the aforementioned any antenna tuner Tuner(m). For better comprehension, the multiple predetermined antenna-tuning configurations may be regarded as multiple predetermined tuner states of the aforementioned any antenna tuner Tuner(m) for being selected, and the digital processing circuit 210 may select any tuner state from the multiple predetermined tuner states when there is a need. For example, the antenna tuning performed on the antenna ANT(m) by the antenna tuner Tuner(m) may comprise aperture tuning and impedance tuning, where the aperture tuning may be regarded as coarse tuning of the antenna tuning, and the impedance tuning may be regarded as fine tuning of the antenna tuning.

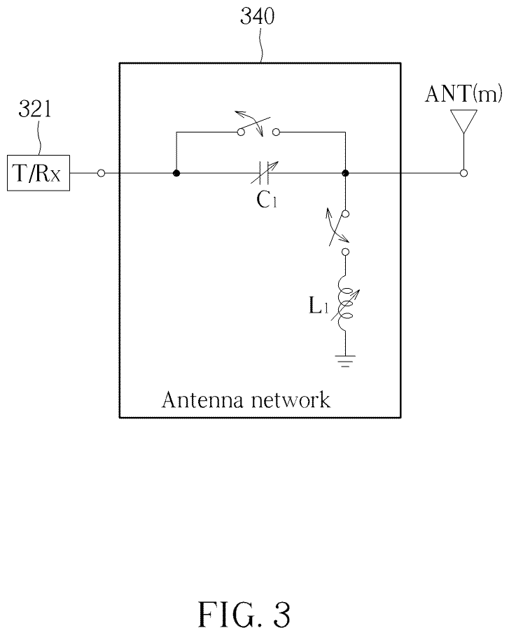

FIG. 3 illustrates an antenna tuning control scheme of the method according to an embodiment of the present invention. The aforementioned any antenna tuner Tuner(m) may be implemented by way of the antenna network 340 shown in FIG. 3, and the FE circuit 221_m that is currently coupled to the aforementioned any antenna tuner Tuner(m) via the switch circuit 230, such as any Tx and Rx FE circuit 221_m among the Tx and Rx FE circuits {221_m|m=0, 1, . . . , (M−1)} or the Rx FE circuit 221_M, may be illustrated as the FE circuit 321 (labeled “T/Rx” for brevity). For example, the antenna network 340 may comprise at least one capacitor (e.g., one or more capacitors) such as the tunable capacitor C₁, at least one inductor (e.g., one or more inductors) such as the tunable inductor L₁, and at least one switch such as multiple switches, but the present invention is not limited thereto. According to some embodiments, the architecture of the antenna network 340 and the arrangement of the components therein, the capacitor count of the aforementioned at least one capacitor, the capacitor type of the aforementioned at least one capacitor, the inductor count of the aforementioned at least one inductor, the inductor type of the aforementioned at least one inductor, and/or the switch count of the aforementioned at least one switch may vary.

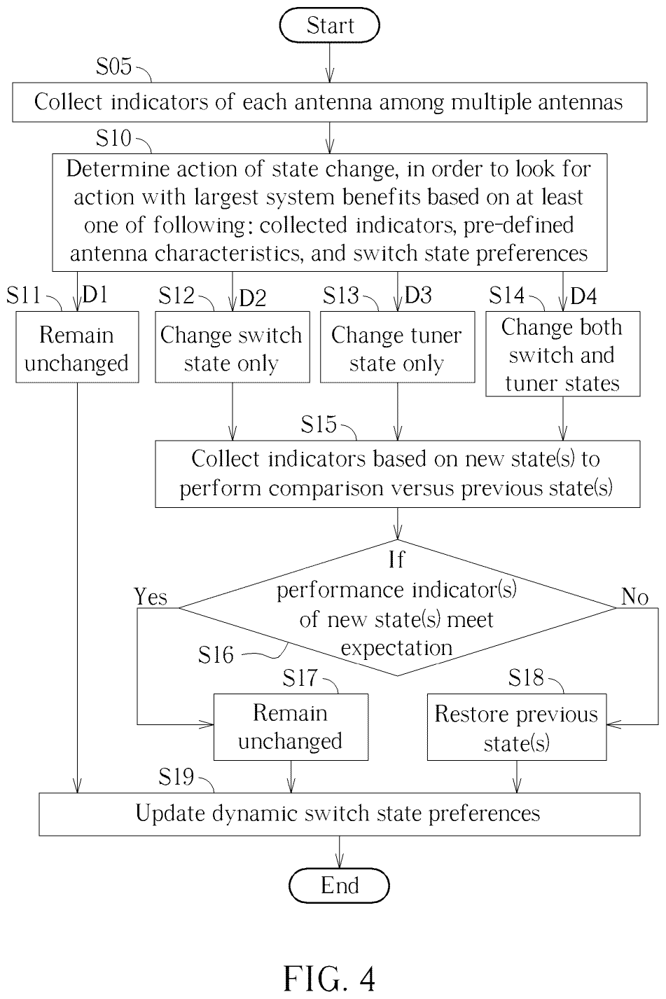

FIG. 4 illustrates a working flow of the method regarding a certain stage among multiple stages according to an embodiment of the present invention. The method can be applied to the aforementioned any wireless transceiver device such as the wireless transceiver device #n or any of the wireless transceiver devices 101, 102, etc. Taking the wireless transceiver device 101 as an example of the wireless transceiver device #n, the communication control circuit 121 within the wireless transceiver device 101 and the aforementioned at least one antenna of the communication control circuit 121 may be implemented by way of the communication control circuit 201 and the (M+1) antennas ANT(0), ANT(1), . . . , ANT(M−1) and ANT(M) shown in FIG. 2, respectively, and the aforementioned any antenna tuner Tuner(m) therein may be implemented by way of the antenna network 340 shown in FIG. 3. In addition, the multiple stages may comprise an offline stage and a runtime stage, and the associated operations of the wireless transceiver device #n may comprise:

(1) during the offline stage, the wireless transceiver device #n may utilize the communication control circuit 201 within the wireless transceiver device #n to characterize antenna performance under different switch states and tuner states offline in order to obtain characterization data (e.g., an antenna characteristic Q_{j, k} for an antenna ANT(j) with a corresponding antenna tuner Tuner(j) in a tuner state k among all tuner states {k} thereof), and setup one or more static switch state preferences based on the characterization data, where the communication control circuit 201 may be arranged to store the characterization data as predetermined characterization data in the storage device 131, for being retrieved and used as reference data in the runtime stage, and the one or more static switch state preferences may represent the likelihood that switch states will be chosen; and

(2) during the runtime stage, the wireless transceiver device #n may utilize the communication control circuit 201 within the wireless transceiver device #n to dynamically determine (or select) any action D(i) among multiple candidate actions {D(i)|i=1, 2, 3, 4} with joint considerations of antenna selection and tuning based on various types of indicators, etc., and perform the aforementioned any action D(i), in order to achieve the optimized system performance; where the multiple candidate actions {D(i)|i=1, 2, 3, 4} may also be referred to as the candidate actions {D1, D2, D3, D4} for brevity. For example, in the runtime stage, the communication control circuit 201 may operate according to the working flow shown in FIG. 4, and more particularly, execute Steps S05 and S10, execute a selected step among Steps S11 to S14, depending on the determined action D(i) such as one of the candidate actions {D1, D2, D3, D4}, and selectively execute at least one portion of steps (e.g., a portion of steps or all steps) among Steps S15 to S19. For example, the associated indicators involved with the method may comprise:
(1) Performance indicators (or “Performance”): the throughput (T-put), the modulation and coding scheme (MCS), the resource block (RB) and the block error rate (BLER) regarding the antenna ANT(m);
(2) Channel Quality indicators (or “Channel Quality”): the reference signal received power (RSRP), the transmission power (TxP), the power headroom report (PHR) and the signal-to-noise ratio (SNR) regarding the antenna ANT(m);
(3) Antenna indicators (or “Antenna”): the impedance measurement(s) such as the measurement result(s) of the impedance of the antenna ANT(m); and
(4) Application Processor (AP) Scenario indicators (or “AP Scenario”): one or more sensor readings of at least one sensor (e.g., gyroscope (gyro) sensor), and at least one Universal Serial Bus (USB) state such as at least one USB plug-in state regarding whether at least one USB port is plugged in;
but the present invention is not limited thereto. In some examples, the associated indicators may vary.

In Step S05, the communication control circuit 201 (or the digital processing circuit 210) may collect at least the indicator(s) of each antenna ANT(m) among the (M+1) antennas ANT(0), ANT(1), . . . , ANT(M−1) and ANT(M).

In Step S10, the communication control circuit 201 (or the digital processing circuit 210) may determine an action D(i) of a state change, with joint considerations of antenna selection and tuning, in order to look for the action D(i) with the largest system benefits based on at least one of the following: the collected indicators (e.g., the Performance indicators, the Channel Quality indicators, the Antenna indicators and the AP Scenario indicators), pre-defined antenna characteristics (e.g., the characterization data such as the antenna characteristic Q_{j, k} for the antenna ANT(j) with the antenna tuner Tuner(j) in the tuner state k), and one or more switch state preferences. For example, the digital processing circuit 210 may obtain the pre-defined antenna characteristics by measuring the RSRP and/or the TxP of the tuner states of the antenna tuner Tuner(m), but the present invention is not limited thereto. In another example, the digital processing circuit 210 may obtain the pre-defined antenna characteristics by deriving from the measured data.

The one or more switch state preferences mentioned in Step S10 may comprise the one or more static switch state preferences, but the present invention is not limited thereto. For examples, the one or more switch state preferences may comprise the one or more static switch state preferences and/or one or more dynamic switch state preferences, where the one or more switch state preferences may have default values such as the one or more static switch state preferences, and the digital processing circuit 210 may update the one or more switch state preferences with one or more changing amounts {A} (e.g., increments or decrements) to dynamically adjust the one or more switch state preferences, which may be regarded as the one or more dynamic switch state preferences.

After executing Step S10, the communication control circuit 201 (or the digital processing circuit 210) may obtain the determined action D(i) such as one of the candidate actions {D1, D2, D3, D4}, and execute the corresponding step among Steps S11 to S14 to perform the corresponding antenna-related control operation, in order to remain no state change, change either the tuner state or the switch state, or change both of the tuner state and the switch state.

In Step S11, when the determined action D(i) is the determined action D1, the communication control circuit 201 (or the digital processing circuit 210) may remain both of the switch state and the tuner state unchanged (labeled “Remain unchanged” for brevity).

In Step S12, when the determined action D(i) is the determined action D2, the communication control circuit 201 (or the digital processing circuit 210) may change the switch state only.

In Step S13, when the determined action D(i) is the determined action D3, the communication control circuit 201 (or the digital processing circuit 210) may change the tuner state only.

In Step S14, when the determined action D(i) is the determined action D4, the communication control circuit 201 (or the digital processing circuit 210) may change both of the switch state and the tuner state.

In Step S15, the communication control circuit 201 (or the digital processing circuit 210) may collect the latest indicators based on the new state(s) to perform comparison versus the previous state(s). For example, if Step S12 is just executed before Step S15 is executed, the new state(s) may comprise the new switch state, and the previous state(s) may comprise the previous switch state. In another example, if Step S13 is just executed before Step S15 is executed, the new state(s) may comprise the new tuner state, and the previous state(s) may comprise the previous tuner state. In yet another example, if Step S14 is just executed before Step S15 is executed, the new state(s) may comprise the new switch state and the new tuner state, and the previous state(s) may comprise the previous switch state and the previous tuner state.

In Step S16, the communication control circuit 201 (or the digital processing circuit 210) may determine if the Performance indicator(s) (or “the Performance”) of the new state(s) meet expectation. If Yes, Step S17 is entered; if No, Step S18 is entered.

In Step S17, the communication control circuit 201 (or the digital processing circuit 210) may remain the new state(s) unchanged (labeled “Remain unchanged” for brevity).

In Step S18, the communication control circuit 201 (or the digital processing circuit 210) may restore the previous state(s).

In Step S19, the communication control circuit 201 (or the digital processing circuit 210) may selectively update the one or more dynamic switch state preferences. For example, the digital processing circuit 210 may adjust the one or more switch state preferences with the one or more changing amounts {4} on top of the one or more static switch state preferences based on the quality of previous decisions.

For better comprehension, the method may be illustrated with the working flow shown in FIG. 4, but the present invention is not limited thereto. According to some embodiments, one or more steps may be added, deleted, or changed in the working flow shown in FIG. 4. For example, after Step S19 is executed, the communication control circuit 201 (or the digital processing circuit 210) may re-enter a previous step (e.g., Step S05) to perform the operations of at least one partial working flow within the working flow shown in FIG. 4. For brevity, similar descriptions for these embodiments are not repeated in detail here.

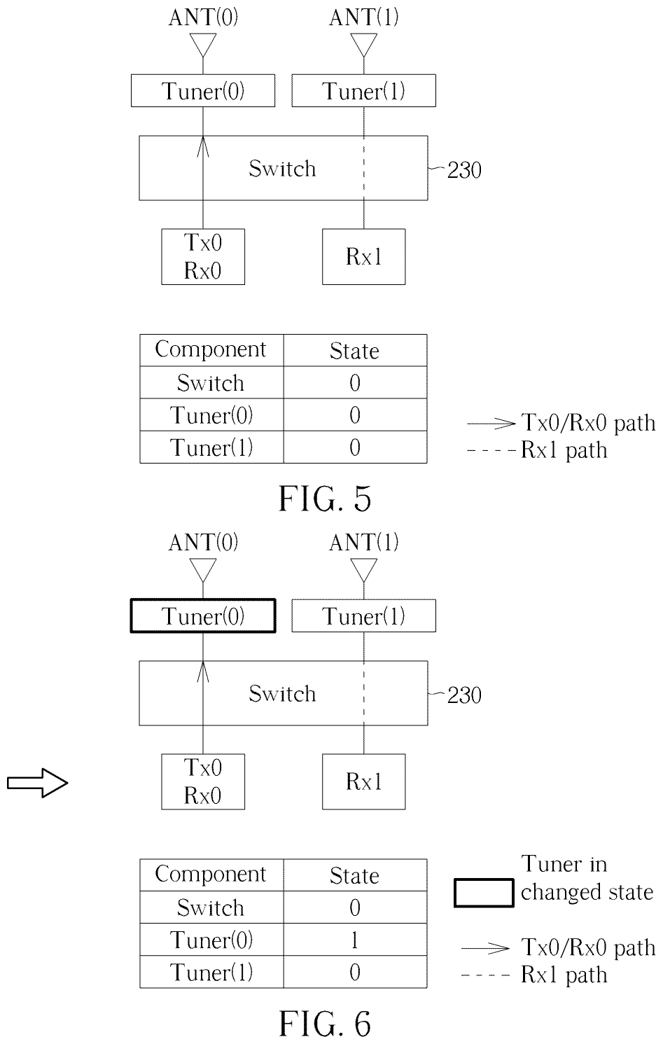

FIG. 5 illustrates a 1T2R joint antenna selection and tuning architecture (e.g., the joint antenna selection and tuning architecture 200 shown in FIG. 2 in a special case of M=1) in at least one default state according to an embodiment of the present invention. In this joint antenna selection and tuning architecture, when M=1, the aforementioned any Tx and Rx FE circuit 221_m among the Tx and Rx FE circuits {221_m|m=0, 1, . . . , (M−1)} and the Rx FE circuit 221_M may be respectively implemented as the Tx and Rx FE circuit 221_0 equipped with the transmitter Tx(0) (or “Tx0”) and the receiver Rx(0) (or “Rx0”) and the Rx FE circuit 221_1 equipped with the receiver Rx(1) (or “Rx1”), respectively labeled as {{Tx0, Rx0}, Rx1} for better comprehension. For example, the switch circuit 230 (labeled “Switch” for brevity) may be in a default switch state 0 thereof as illustrated with the Tx0/Rx0 path and the Rx1 path shown in FIG. 5, the antenna tuner Tuner(0) may be in a default tuner state 0 thereof, and the antenna tuner Tuner(1) may be in a default tuner state 0 thereof, where the aforementioned at least one default state may comprise the switch state 0 of the switch circuit 230, the tuner state 0 of the antenna tuner Tuner(0) and the tuner state 0 of the antenna tuner Tuner(1), but the present invention is not limited thereto. According to some embodiments, the aforementioned at least one default state, the switch state of the switch circuit 230, the tuner state of the antenna tuner Tuner(0), and/or the tuner state of the antenna tuner Tuner(1) may vary.

The combination (k0, k1, k2) of the switch state k0 (e.g., any switch state k0 among the switch states {0, 1}) of the switch circuit 230, the tuner state k1 (e.g., any tuner state k1 among the tuner states {0, 1, . . . }) of the antenna tuner Tuner(0) and the tuner state k2 (e.g., any tuner state k2 among the tuner states {0, 1, . . . }) of the antenna tuner Tuner(1) may be regarded as a hybrid state (k0, k1, k2) of the 1T2R joint antenna selection and tuning architecture. When the digital processing circuit 210 determines the action D(i) as the determined action D1 in Step S10, the communication control circuit 201 may execute Step S11 corresponding to the determined action D1 keep staying in the current hybrid state (k0, k1, k2). When the digital processing circuit 210 determines the action D(i) as any determined action among the determined actions D2, D3 and D4 in Step S10, the communication control circuit 201 may execute the step corresponding to the aforementioned any determined action among Steps S12, S13 and S14, to make the 1T2R joint antenna selection and tuning architecture transit from one hybrid state (k0, k1, k2) to another hybrid state (k0, k1, k2). As shown in FIG. 5, the combination (0, 0, 0) of the switch state 0 of the switch circuit 230, the tuner state 0 of the antenna tuner Tuner(0) and the tuner state 0 of the antenna tuner Tuner(1) may be regarded as the hybrid state (0, 0, 0).

In Step S10, the digital processing circuit 210 may determine the action D(i) as the determined action D(i) among the determined actions D1, D2, D3 and D4 according to the collected indicators (e.g., the indicators collected in Step S05) obtained in the runtime stage and some other indicators obtained in the offline stage. Regarding any antenna ANT(j) among the antennas {ANT(m)|m=0, 1, . . . , (M−1), M}, the indicators for determining the action D(i) in Step S10 may comprise one or a combination of the following: the antenna characteristic Q_{j, k} for the antenna ANT(j) with the corresponding antenna tuner Tuner(j) in the tuner state k(e.g., the tuner state k(j+1) of the antenna tuner Tuner(j)), the switch state preference Pₖ₀ for the switch state k0, the PHR PHRⱼ, the SNR SNRⱼ and the RSRP RSRPⱼ, but the present invention is not limited thereto. According to some embodiments, the indicators for determining the action D(i) in Step S10 may vary. In addition, the digital processing circuit 210 may perform at least one comparison operation (e.g., one or more comparison operations), and more particularly, compare at least one indicator among the indicators with at least one predetermined threshold of the aforementioned at least one indicator, in order to determine the action D(i). For example, the aforementioned at least one indicator may comprise the PHR PHRⱼ, and the aforementioned at least one predetermined threshold may comprise the PHR threshold THD_{PHR}. In a first comparison operation, the digital processing circuit 210 may compare the PHR PHRⱼ with the PHR threshold THD_{PHR}, for determining the action D(i) at least according to whether the PHR PHRⱼ reaches (e.g., is greater than or equal to) the PHR threshold THD_{PHR}. For another example, the aforementioned at least one indicator may comprise the SNR SNRⱼ, and the aforementioned at least one predetermined threshold may comprise the SNR threshold THD_{SNR}. In a second comparison operation, the digital processing circuit 210 may compare the SNR SNRⱼ with the SNR threshold THD_{SNR}, for determining the action D(i) at least according to whether the SNR SNRⱼ reaches (e.g., is greater than or equal to) the SNR threshold THD_{SNR}.

FIG. 6 illustrates the 1T2R joint antenna selection and tuning architecture (e.g., the joint antenna selection and tuning architecture 200 shown in FIG. 2 in the special case of M=1) in a first tuner state (e.g., the tuner state 1 of the antenna tuner Tuner(0)) according to an embodiment of the present invention. For example, the digital processing circuit 210 may determine the action D(i) as the determined action D3 in Step S10, and change the tuner state only in Step S13, and more particularly, change the tuner state based on the collected indicators, to make the 1T2R joint antenna selection and tuning architecture transit from the hybrid state (0, 0, 0) to the hybrid state (0, 1, 0).

TABLE 1

| | |
|---|---|
| Indicator | PHR₀ < THD_{PHR}, PHR₁ < THD_{PHR} |
| | SNR₀ ≥ THD_{SNR}, SNR₁ ≥ THD_{SNR} |
| | RSRP₀ + Q_{0, 1} ≥ RSRP₁ + P₁ + Q_{1, 1} |
| Action | As there is no benefit switching to ANT(1), |
| | change tuner state only to improve PHR₀ |

Table 1 illustrates an example of the indicators, as well as the associated comparison operations and the associated action. When PHR₀<THD_{PHR} and PHR₁<THD_{PHR}, the digital processing circuit 210 may not merely rely on the PHRs PHR₀ and PHR₁ for determining the action D(i) since there is no difference between switching to the antenna ANT(1) and not switching to the antenna ANT(1). When SNR₀≥THD_{SNR} and SNR₁≥THD_{SNR}, the digital processing circuit 210 may not merely rely on the SNRs SNR₀ and SNR₁ for determining the action D(i) since there is no difference between switching to the antenna ANT(1) and not switching to the antenna ANT(1). When RSRP₀+Q_{0,1}≥RSRP₁+P₁+Q_{1,1}, which may indicate that the score (e.g., a total score of some indicators acting as scores) of switching to the antenna ANT(1) is less than the score of not switching to the antenna ANT(1), the digital processing circuit 210 may determine that switching to the antenna ANT(1) will not improve the overall performance, and therefore may change the tuner state only to improve PHR₀.

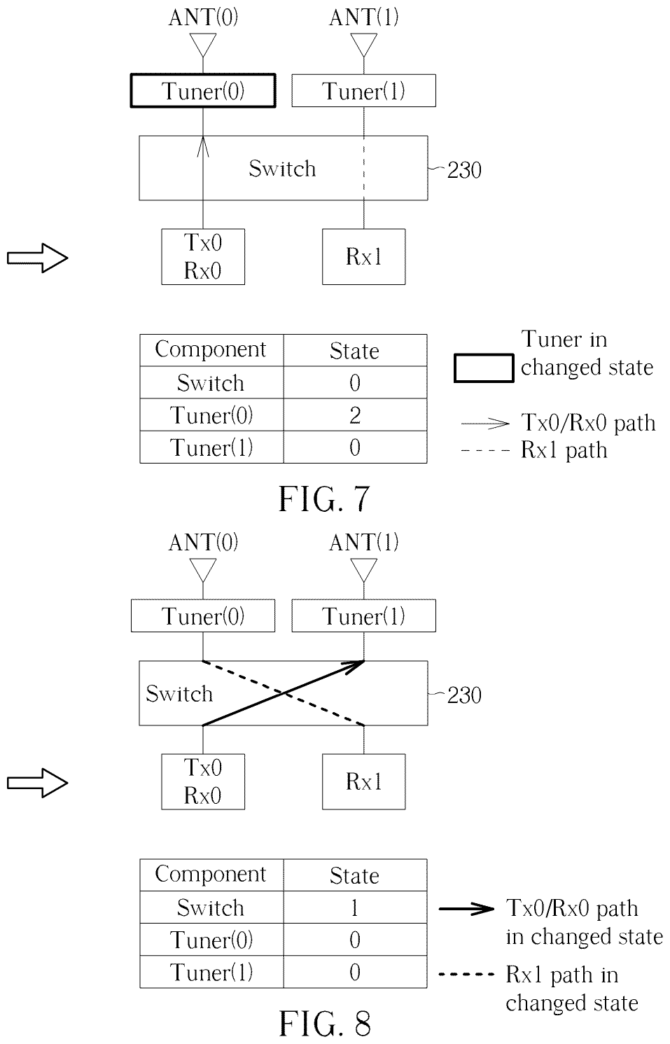

FIG. 7 illustrates the 1T2R joint antenna selection and tuning architecture (e.g., the joint antenna selection and tuning architecture 200 shown in FIG. 2 in the special case of M=1) in a second tuner state (e.g., the tuner state 2 of the antenna tuner Tuner(0)) according to an embodiment of the present invention. For example, the digital processing circuit 210 may determine the action D(i) as the determined action D3 in Step S10, and change the tuner state only in Step S13, and more particularly, change the tuner state based on the collected indicators, to make the 1T2R joint antenna selection and tuning architecture transit from the hybrid state (0, 0, 0) to the hybrid state (0, 2, 0).

TABLE 2

| | |
|---|---|
| Indicator | SNR₀ < THD_{SNR}, SNR₁ < THD_{SNR} |
| | RSRP₀ + Q_{0, 2} ≥ RSRP₁ + P₁ + Q_{1, 2} |
| Action | As there is no benefit switching to ANT(1), |
| | change tuner state only to improve SNR₀ |

Table 2 illustrates another example of the indicators, as well as the associated comparison operations and the associated action. When SNR₀<THD_{SNR} and SNR₁<THD_{SNR}, the digital processing circuit 210 may not merely rely on the SNRs SNR₀ and SNR₁ for determining the action D(i) since there is no difference between switching to the antenna ANT(1) and not switching to the antenna ANT(1). When RSRP₀+Q_{0,2}≥RSRP₁+P₁+Q_{1,2}, which may indicate that the score of switching to the antenna ANT(1) is less than the score of not switching to the antenna ANT(1), the digital processing circuit 210 may determine that switching to the antenna ANT(1) will not improve the overall performance, and therefore may change the tuner state only to improve PHR₀.

According to the embodiment shown in FIG. 6, the digital processing circuit 210 may determine the action D(i) as the determined action D3 in Step S10, and change the tuner state only in Step S13, and more particularly, change the tuner state based on the collected indicators, to make the 1T2R joint antenna selection and tuning architecture transit from the hybrid state (0, 0, 0) to the hybrid state (0, 1, 0), where the indicators shown in Table 1 may vary as shown in Table 3.

TABLE 3

| | |
|---|---|
| Indicator | PHR₀ < THD_{PHR}, PHR₁ < THD_{PHR} |
| | SNR₀ ≥ THD_{SNR}, SNR₁ ≥ THD_{SNR} |
| | RSRP₀ + Q_{0, 1} ≥ RSRP₁ + P₁ |
| Action | As there is no benefit switching to ANT(1), |
| | change tuner state only to improve PHR₀ |

Table 3 illustrates another example of the indicators, as well as the associated comparison operations and the associated action. When PHR₀<THD_{PHR} and PHR₁<THD_{PHR}, the digital processing circuit 210 may not merely rely on the PHRs PHR₀ and PHR₁ for determining the action D(i) since there is no difference between switching to the antenna ANT(1) and not switching to the antenna ANT(1). When SNR₀≥THD_{SNR} and SNR₁≥THD_{SNR}, the digital processing circuit 210 may not merely rely on the SNRs SNR₀ and SNR₁ for determining the action D(i) since there is no difference between switching to the antenna ANT(1) and not switching to the antenna ANT(1). When RSRP₀+Q_{0,1}≥RSRP₁+P₁, which may indicate that the score of switching to the antenna ANT(1) is less than the score of not switching to the antenna ANT(1), the digital processing circuit 210 may determine that switching to the antenna ANT(1) will not improve the overall performance, and therefore may change the tuner state only to improve PHR₀.

FIG. 8 illustrates the 1T2R joint antenna selection and tuning architecture (e.g., the joint antenna selection and tuning architecture 200 shown in FIG. 2 in the special case of M=1) in a first switch state (e.g., the switch state 1 of the switch circuit 230) according to an embodiment of the present invention. For example, the digital processing circuit 210 may determine the action D(i) as the determined action D2 in Step S10, and change the switch state only in Step S12, and more particularly, change the switch state based on the collected indicators, to make the 1T2R joint antenna selection and tuning architecture transit from the hybrid state (0, 0, 0) to the hybrid state (1, 0, 0).

TABLE 4

| | |
|---|---|
| Indicator | PHR₀ ≥ THD_{PHR}, PHR₁ ≥ THD_{PHR} |
| | SNR₀ ≥ THD_{SNR}, SNR₁ ≥ THD_{SNR} |
| | RSRP₀ < RSRP₁ + P₁ |
| Action | Change switch state only, to switch to ANT(1) for |
| | better performance, where conditions for tuner state |
| | change are not triggered |

Table 4 illustrates another example of the indicators, as well as the associated comparison operations and the associated action. When PHR₀≥THD_{PHR} and PHR₁≥THD_{PHR}, the digital processing circuit 210 may not merely rely on the PHRs PHR₀ and PHR₁ for determining the action D(i) since there is no difference between switching to the antenna ANT(1) and not switching to the antenna ANT(1). When SNR₀≥THD_{SNR} and SNR₁≥THD_{SNR}, the digital processing circuit 210 may not merely rely on the SNRs SNR₀ and SNR₁ for determining the action D(i) since there is no difference between switching to the antenna ANT(1) and not switching to the antenna ANT(1). When RSRP₀<RSRP₁+P₁, which may indicate that the score of switching to the antenna ANT(1) is greater than the score of not switching to the antenna ANT(1), the digital processing circuit 210 may determine that switching to the antenna ANT(1) will improve the overall performance, and therefore may change the switch state only, to switch to the antenna ANT(1) for better performance, where the conditions for the tuner state change are not triggered.

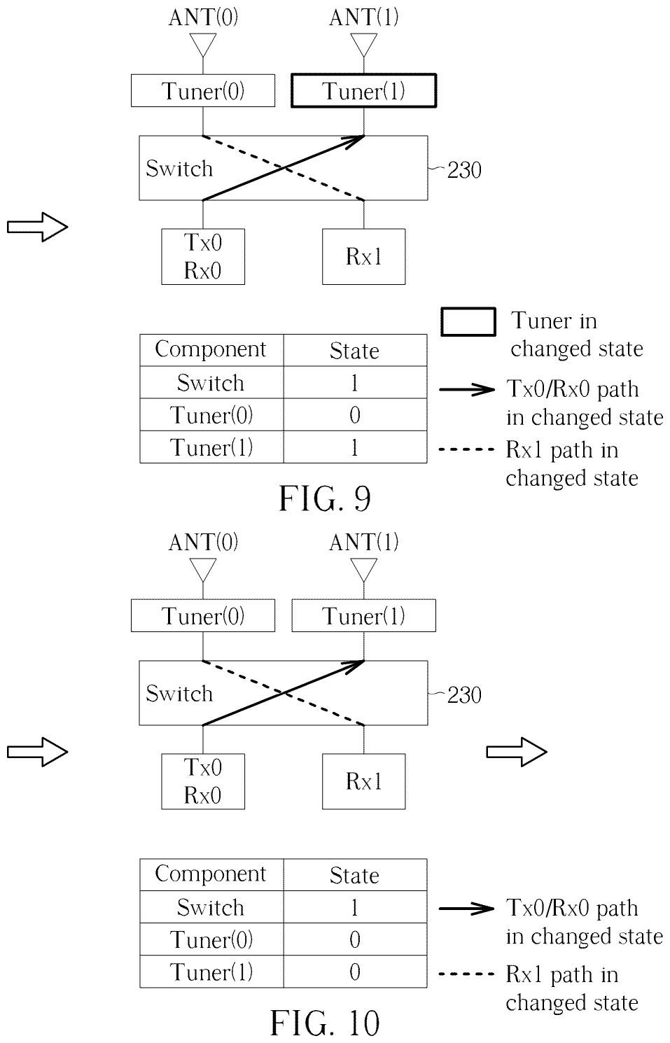

FIG. 9 illustrates the 1T2R joint antenna selection and tuning architecture (e.g., the joint antenna selection and tuning architecture 200 shown in FIG. 2 in the special case of M=1) in the first switch state (e.g., the switch state 1 of the switch circuit 230) and another tuner state (e.g., the tuner state 1 of the antenna tuner Tuner(1)) according to an embodiment of the present invention. For example, the digital processing circuit 210 may determine the action D(i) as the determined action D4 in Step S10, and change both of the switch state and the tuner state in Step S14, and more particularly, change the switch state and the tuner state based on the collected indicators, to make the 1T2R joint antenna selection and tuning architecture transit from the hybrid state (0, 0, 0) to the hybrid state (1, 0, 1).

TABLE 5

| | |
|---|---|
| Indicator | PHR₀ < THD_{PHR}, PHR₁ ≥ THD_{PHR} |
| | SNR₀ ≥ THD_{SNR}, SNR₁ < THD_{SNR} |
| | RSRP₀ < RSRP₁ + P₁ + Q_{1, 1} |
| Action | Change both switch and tuner states, to switch to |
| | ANT(1) for better performance and change tuner state |
| | to improve SNR₁ |

Table 5 illustrates another example of the indicators, as well as the associated comparison operations and the associated action. When PHR₀<THD_{PHR} and PHR₁≥THD_{PHR}, which may indicate that switching to the antenna ANT(1) is better than not switching to the antenna ANT(1), the digital processing circuit 210 may determine that switching to the antenna ANT(1) is needed for better performance. When SNR₀≥THD_{SNR} and SNR₁<THD_{SNR}, which may indicate that, without further action such as changing the tuner state, the SNR would decrease from the SNR SNR₀ reaching the SNR threshold THD_{SNR} to the SNR SNR₁ below the SNR threshold THD_{SNR}, the digital processing circuit 210 may determine that switching to another tuner state is needed for improving the SNR SNR₁. When RSRP₀<RSRP₁+P₁+Q_{1,1}, which may indicate that the score of switching to the antenna ANT(1) while controlling the antenna tuner Tuner(1) to switch to the tuner state 1 thereof is greater than the score of not switching to the antenna ANT(1), the digital processing circuit 210 may determine that switching to the antenna ANT(1) will improve the overall performance, and therefore may change both of the switch state and the tuner state, to switch to the antenna ANT(1) for better performance and change the tuner state of the antenna tuner Tuner(1) to improve the SNR SNR₁.

FIG. 10 illustrates the 1T2R joint antenna selection and tuning architecture (e.g., the joint antenna selection and tuning architecture 200 shown in FIG. 2 in the special case of M=1) in the first switch state (e.g., the switch state 1 of the switch circuit 230) according to another embodiment of the present invention. For example, the digital processing circuit 210 may determine the action D(i) as the determined action D2 in Step S10, and change the switch state only in Step S12, and more particularly, change the switch state based on the collected indicators, to make the 1T2R joint antenna selection and tuning architecture transit from the hybrid state (0, 0, 0) to the hybrid state (1, 0, 0).

TABLE 6

| | |
|---|---|
| Indicator | PHR₀ ≥ THD_{PHR}, PHR₁ ≥ THD_{PHR} |
| | SNR₀ ≥ THD_{SNR}, SNR₁ ≥ THD_{SNR} |
| | RSRP₀ < RSRP₁ + P₁ |
| Action | Change switch state only |

Table 6 illustrates another example of the indicators, as well as the associated comparison operations and the associated action. When PHR₀≥THD_{PHR} and PHR₁≥THD_{PHR}, the digital processing circuit 210 may not merely rely on the PHRs PHR₀ and PHR₁ for determining the action D(i) since there is no difference between switching to the antenna ANT(1) and not switching to the antenna ANT(1). When SNR₀≥THD_{SNR} and SNR₁≥THD_{SNR}, the digital processing circuit 210 may not merely rely on the SNRs SNR₀ and SNR₁ for determining the action D(i) since there is no difference between switching to the antenna ANT(1) and not switching to the antenna ANT(1). When RSRP₀<RSRP₁+P₁, which may indicate that the score of switching to the antenna ANT(1) is greater than the score of not switching to the antenna ANT(1), the digital processing circuit 210 may determine that switching to the antenna ANT(1) will improve the overall performance, and therefore may change the switch state only, to switch to the antenna ANT(1), but the overall performance may degrade after this. The digital processing circuit 210 may detect that at least one Performance indicator (or “the Performance”) such as the throughput T-put(k0, k1, k2) corresponding to the hybrid state (k0, k1, k2) degrades, and determine to leave the new state(s) right away.

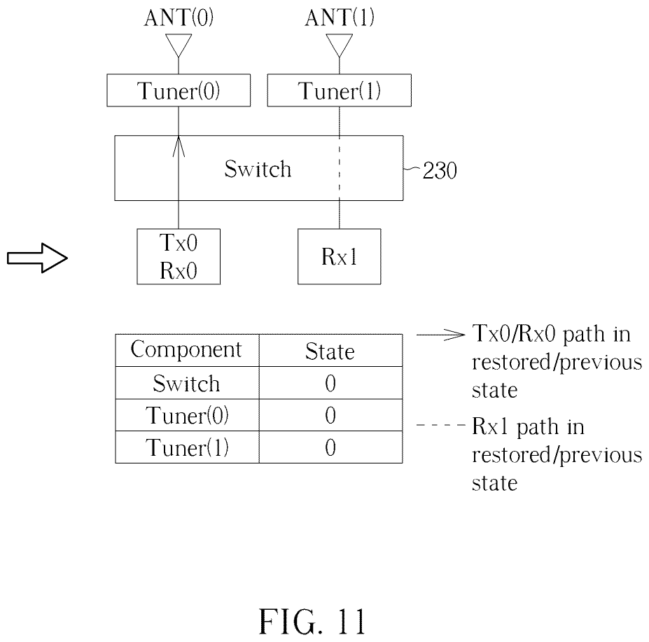

FIG. 11 illustrates the 1T2R joint antenna selection and tuning architecture (e.g., the joint antenna selection and tuning architecture 200 shown in FIG. 2 in the special case of M=1) in the restored switch state (e.g., the switch state 0 of the switch circuit 230) according to the embodiment shown in FIG. 10. For example, the digital processing circuit 210 may determine in Step S16 that the Performance indicator(s) of the new state(s) do not meet the expectation, and therefore execute Step S18 to restore the previous state(s) and execute Step S19 to update the one or more dynamic switch state preferences such as the switch state preference P₁ for the switch state 1.

TABLE 7

| | |
|---|---|
| Indicator | T-put degrades: |
| | T-put(0, 0, 0) > T-put(1, 0, 0) |
| Action | Restore previous state |
| | P₁ = P₁ − Δ |

Table 7 illustrates an example of the Performance indicator(s) used in Step S16, as well as the associated comparison result and the associated actions. When T-put(0, 0, 0)>T-put(1, 0, 0), which may indicate that the throughput T-put(0, 0, 0) corresponding to the previous hybrid state (0, 0, 0) is greater than the throughput T-put(1, 0, 0) corresponding to the new hybrid state (1, 0, 0), the digital processing circuit 210 may determine that restoring the previous state(s) such as the previous hybrid state (0, 0, 0) will improve the overall performance, and therefore may switch back to the previous hybrid state (0, 0, 0). In addition, the digital processing circuit 210 may update the one or more dynamic switch state preferences such as the switch state preference P₁ for the switch state 1, and more particularly, adjust the switch state preference P₁ with the changing amount Δ based on the quality of the previous decisions regarding the switch state 1.

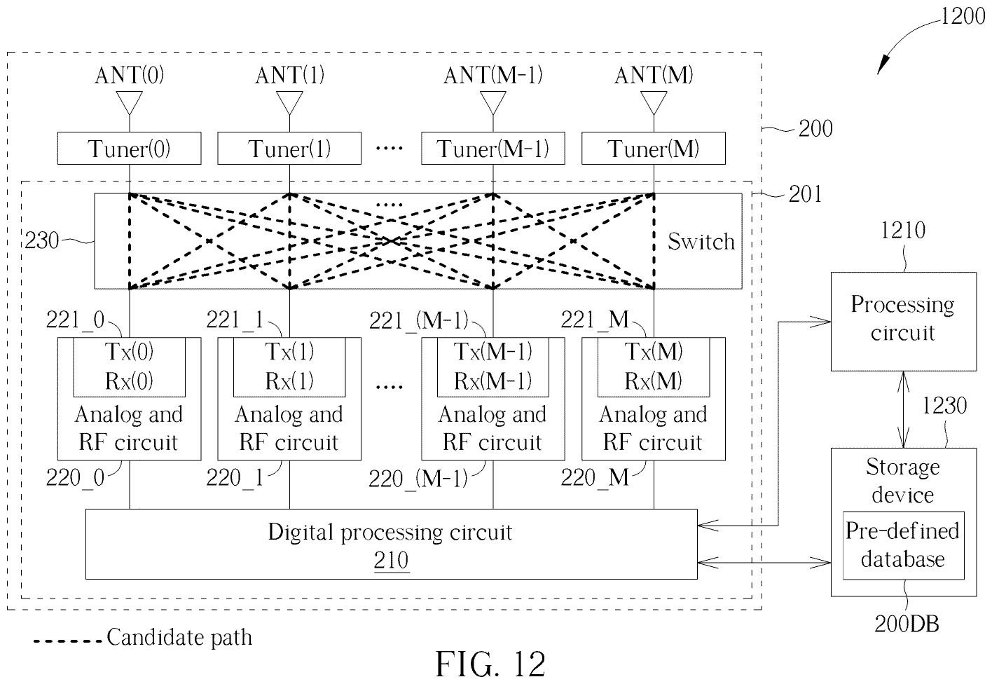

FIG. 12 illustrates a wireless transceiver device 1200 equipped with the joint antenna selection and tuning architecture 200 shown in FIG. 2 according to an embodiment of the present invention. The wireless transceiver device 1200 can be taken as an example of the wireless transceiver device #n, and the processing circuit 1210 and the storage device 1230 storing the pre-defined database 200 DB therein can be taken as examples of the processing circuit and the storage device within the wireless transceiver device #n, respectively. For better comprehension, when n=1, the wireless transceiver device 1200 as well as the processing circuit 1210, the communication control circuit 201 and the storage device 1230 therein may represent the wireless transceiver device 101 as well as the processing circuit 111, the communication control circuit 121 and the storage device 131 therein, respectively; when n=2, the wireless transceiver device 1200 as well as the processing circuit 1210, the communication control circuit 201 and the storage device 1230 therein may represent the wireless transceiver device 102 as well as the processing circuit 112, the communication control circuit 122 and the storage device 132 therein, respectively; and the rest can be deduced by analogy. For brevity, similar descriptions for this embodiment are not repeated in detail here.

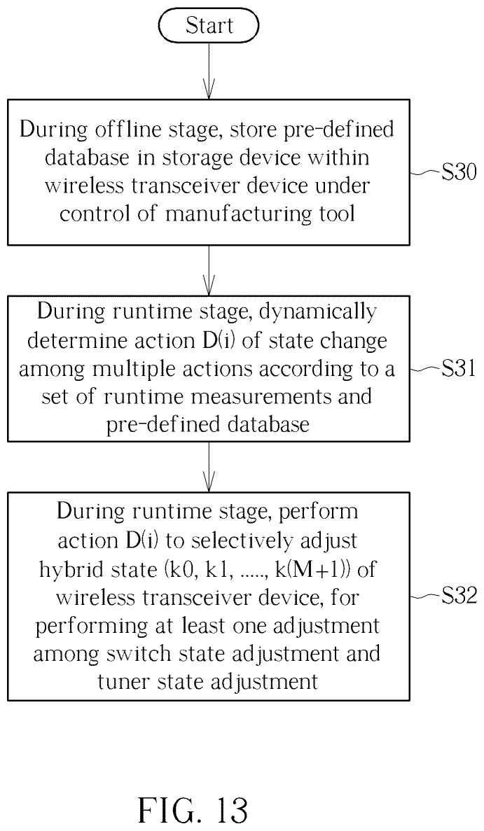

FIG. 13 illustrates a working flow of the method regarding the multiple stages (e.g., the offline stage and the runtime stage) according to an embodiment of the present invention.

In Step S30, during the offline stage among the multiple stages, the wireless transceiver device 1200 (or at least one circuit therein, such as the processing circuit 1210, the communication control circuit 201 and/or the digital processing circuit 210) may store the pre-defined database 200 DB in the storage device 1230 within the wireless transceiver device 1200 under control of a manufacturing tool. For example, the manufacturing tool may represent a manufacturing tool device (e.g., a personal computer such as a desktop computer or a laptop computer) coupled to the wireless transceiver device 1200, but the present invention is not limited thereto. In some examples, the manufacturing tool may represent a manufacturing tool program module running on the processing circuit 1210 within the wireless transceiver device 1200.

In Step S31, during the runtime stage among the multiple stages, the communication control circuit 201 (or the digital processing circuit 210 therein) may dynamically determine any action D(i) of the state change among multiple actions {D(i)|i=1, 2, 3, 4} (e.g., the determined actions D2, D3 and D4) according to a set of runtime measurements and the pre-defined database 200 DB in the storage device 1230 within the wireless transceiver device 1200. For example, the operation of Step S31 may comprise the operation of Step S10 shown in FIG. 4, and more particularly, comprise the operations of Steps S05 and S10 shown in FIG. 4.

In Step S32, during the runtime stage, the communication control circuit 201 (or the digital processing circuit 210 therein) may perform the any action D(i) (e.g., the action D(i) that is just determined in Step S31) to selectively adjust the hybrid state (k0, k1, . . . , k(M+1)) of the wireless transceiver device 1200, such as the combination (k0, k1, . . . , k(M+1)) of the switch state k0 of the switch circuit 230 for the antenna selection within the communication control circuit 201 and at least one tuner state k(m+1) (e.g., the tuner states {k(m+1)|m=0, . . . , M}) of at least one antenna tuner Tuner(m) (e.g., the antenna tuners {Tuner(m)|m=0, . . . , M}) for the antenna tuning within the communication control circuit 201, for performing at least one adjustment among a switch state adjustment of the switch state k0 and a tuner state adjustment of the tuner state k(m+1). For example, the operation of Step S32 may comprise the operation of any step among Steps S11 to S14 shown in FIG. 4.

The set of runtime measurements may comprise one or a combination of the throughput T-put(k0, k1, . . . , k(M+1)), the MCS, the RB, the BLER, the RSRP RSRPⱼ, the TxP, the PHR PHRⱼ, the SNR SNRⱼ and the impedance regarding any antenna ANT(j) among multiple antennas {ANT(m)|m=0, 1, . . . , (M−1), M} of the wireless transceiver device 1200. In addition, the pre-defined database 200 DB may comprise the characterization data that is obtained during the offline stage, wherein during the runtime stage, the communication control circuit 201 may dynamically determine the any action D(i) according to the set of runtime measurements and the characterization data. More particularly, the characterization data may comprise a set of antenna characteristics {Q_{j, k}} (e.g., the antenna characteristic Q_{j, k} for the antenna ANT(j) with the corresponding antenna tuner Tuner(j) in the tuner state k among all tuner states {k} thereof) corresponding to the switch state and tuner state characterization of the switch state k0 and the aforementioned at least one tuner state k(m+1). For example, the set of antenna characteristics may be measured and/or customized, and stored as at least one portion of the pre-defined database 200 DB. The set of antenna characteristics may comprise one or a combination of a RSRP measurement (e.g., a measurement result of the RSRP), a TxP measurement (e.g., a measurement result of the TxP), a total isotropic sensitivity (TIS) measurement (e.g., a measurement result of the TIS) and a total radiated power (TRP) measurement (e.g., a measurement result of the TRP) at each state among multiple hybrid states {(k0, k1, . . . , k(M+1))} (e.g., all hybrid states {(k0, k1, . . . , k(M+1))}) of the wireless transceiver device 1200. Additionally, the characterization data may further comprise at least one state preference of at least one state among all tuner and switch states (e.g., all switch states {k0} and all tuner states {{k1}, . . . , {k(M+1)}}), such as the switch state preference Pₖ₀ for the state k of the switch circuit 230 and the tuner state preference PTₖ₍ₘ₊₁₎ for the state k(m+1) of the antenna tuner Tuner(m), for controlling the likelihood of the aforementioned at least one state being selected during the runtime stage.

For better comprehension, the method may be illustrated with the working flow shown in FIG. 13, but the present invention is not limited thereto. According to some embodiments, one or more steps may be added, deleted, or changed in the working flow shown in FIG. 13. For example, after Step S32 is executed, the communication control circuit 201 (or the digital processing circuit 210) may execute at least one subsequent step in the runtime stage, where the aforementioned at least one subsequent step may comprise Steps S15 to S19 shown in FIG. 4. For brevity, similar descriptions for these embodiments are not repeated in detail here.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for performing antenna control with aid of joint decision of antenna selection and tuning for antenna performance optimization, the method being applicable to a wireless transceiver device, the method comprising:
during a runtime stage among multiple stages, dynamically determining, by a communication control circuit within the wireless transceiver device, any action of a state change among multiple actions according to a set of runtime measurements and a pre-defined database in a storage device within the wireless transceiver device; and
during the runtime stage, performing, by the communication control circuit, the any action to selectively adjust a hybrid state of the wireless transceiver device, the hybrid state being a combination of a switch state of a switch circuit for antenna selection within the communication control circuit and at least one tuner state of at least one antenna tuner for antenna tuning within the communication control circuit, for performing at least one adjustment among a switch state adjustment and a tuner state adjustment.

2. The method of claim 1, wherein the set of runtime measurements comprise one or a combination of a throughput (T-put), a modulation and coding scheme (MCS), a resource block (RB), a block error rate (BLER), a reference signal received power (RSRP), a transmission power (TxP), a power headroom report (PHR), a signal-to-noise ratio (SNR) and an impedance regarding any antenna among multiple antennas of the wireless transceiver device.

3. The method of claim 1, wherein the pre-defined database comprises characterization data that is obtained during an offline stage among the multiple stages; and during the runtime stage, the communication control circuit is arranged to dynamically determine the any action according to the set of runtime measurements and the characterization data.

4. The method of claim 3, wherein the characterization data comprises a set of antenna characteristics, the set of antenna characteristics corresponding to switch state and tuner state characterization of the switch state and the at least one tuner state.

5. The method of claim 4, wherein the set of antenna characteristics are measured and stored as at least one portion of the pre-defined database.

6. The method of claim 4, wherein the set of antenna characteristics comprise one or a combination of a reference signal received power (RSRP) measurement, a transmission power (TxP) measurement, a total isotropic sensitivity (TIS) measurement and a total radiated power (TRP) measurement at each state among multiple hybrid states of the wireless transceiver device.

7. The method of claim 4, wherein the characterization data further comprises at least one state preference of at least one state among all tuner and switch states, for controlling a likelihood of the at least one state being selected during the runtime stage.

8. A wireless transceiver device, for performing antenna control of the wireless transceiver device in a wireless communication system with aid of joint decision of antenna selection and tuning for antenna performance optimization, the wireless transceiver device being one of multiple devices within the wireless communication system, the wireless transceiver device comprising:
a processing circuit, arranged to control operations of the wireless transceiver device; and
at least one communication control circuit, coupled to the processing circuit, arranged to perform communication control, wherein the at least one communication control circuit is arranged to perform wireless communication operations with a network within the wireless communication system for the wireless transceiver device;
wherein:
during a runtime stage among multiple stages, the at least one communication control circuit is arranged to dynamically determine any action of a state change among multiple actions according to a set of runtime measurements and a pre-defined database in a storage device within the wireless transceiver device; and
during the runtime stage, the at least one communication control circuit is arranged to perform the any action to selectively adjust a hybrid state of the wireless transceiver device, the hybrid state being a combination of a switch state of a switch circuit for antenna selection within the communication control circuit and at least one tuner state of at least one antenna tuner for antenna tuning within the communication control circuit, for performing at least one adjustment among a switch state adjustment and a tuner state adjustment.
